(19) United States
(12) Patent Application Publication
(10) Pub. No.: US 2025/0184030 A1
(43) Pub. Date: Jun. 5, 2025

(54) WDM MODULE FOR MULTIMODE LIGHT SOURCE

(71) Applicant: OPTICIS CO., LTD., Seongnam-si (KR)

(72) Inventors: Seong Geun KIM, Gwangju (KR); Hee Dae KIM, Gwangju (KR)

(73) Assignee: OPTICIS CO., LTD., Seongnam-si (KR)

(21) Appl. No.: 18/828,281

(22) Filed: Sep. 9, 2024

(30) Foreign Application Priority Data
Dec. 1, 2023 (KR) 10-2023-0172178
Dec. 1, 2023 (KR) 10-2023-0172199
May 27, 2024 (KR) 10-2024-0068486

(51) Int. Cl. H04J 14/02; G02B 6/12; G02B 6/122

(52) U.S. Cl. CPC H04J 14/0307; G02B 6/12007; G02B 6/122; H04J 14/0305; G02B 2006/12102; G02B 2006/12104; G02B 2006/12164

(57) ABSTRACT

Disclosed is a WDM module for a multimode light source. An aspect of the present embodiment provides a WDM module for a multimode light source that simplifies the arrangement/structure of elements included therein and is resistant to temperature. The WDM module includes a base substrate, at least two optical elements configured to receive or output light of different wavelength bands, an optical path conversion unit, a collimator, an optical path adjustment unit, and a reflection unit.

### CROSS-REFERENCE TO RELATED APPLICATION

This application claims priority to Korean Patent Application No. 10-2023-0172178 filed on Dec. 1, 2023, Korean Patent Application No. 10-2023-0172199 filed on Dec. 1, 2023, and Korean Patent Application No. 10-2024-0068486 filed on May 27, 2024, the entire contents of which are herein incorporated by reference.

These patents are the results of research that was carried out by the support (a unique project number: 1415187229, a detailed project number: 20022914, a project name: The development of 32 HD-level image processing systems using WDM modules for multi-mode light sources) of the Korea Planning & Evaluation Institute of Industrial Technology by the finances of the government of the Republic of Korea (The Ministry of Trade, Industry and Energy) in 2023.

### BACKGROUND

### 1. Technical Field

The present disclosure relates to a WDM module for a multimode light source.

### 2. Related Art

Contents described in this part merely provide background information of the present embodiment, and do not constitute a conventional technology.

Fiber optic cables are widely used to transmit signals between video sources (e.g., video players, video signal switches, computers, and the like) and display devices (e.g., digital televisions, monitors, and the like). The signals transmitted between the video sources and the display devices often include audio signals, data signals (e.g., USB format data signals for peripheral devices), and the like in addition to video signals. The video signal has a format according to a standard video transmission format such as a high definition multimedia interface (HDMI), a DisplayPort (DP), a digital visual interface (DVI), or a video graphics array (VGA).

The fiber optic cables may support wavelength division multiplexing (WDM) optical communication for transmitting optical signals of different wavelength bands by using one optical fiber, and provide a plurality of communication channels.

However, a conventional WDM module has the problem of causing unintended changes in an optical path due to temperature in transmitting/receiving optical signals of different wavelength bands, and has the problem of inconvenient alignment in disposing optical elements within the module.

### SUMMARY

Embodiments of the present disclosure are directed to providing a WDM module for a multimode light source that simplifies the arrangement/structure of elements included therein and is resistant to temperature.

According to an aspect of the present disclosure, a WDM module for a multimode light source may include a base substrate, at least two optical elements configured to receive or output light of different wavelength bands, an optical path conversion unit disposed between an optical fiber for outputting or receiving light and the optical element on an optical path, and configured to convert the optical path so that light emitted from one component travels to another component, a collimator located between the optical fiber and the optical path conversion unit on the optical path, and configured to allow the light emitted from the optical fiber to travel as parallel light and allow the light with a path changed by the optical path conversion unit to be focused to the optical fiber, an optical path adjustment unit located between the optical path conversion unit and the optical element on the optical path, and configured to adjust a path of light traveling from one component to another component, and a reflection unit configured to reflect the light passing through the optical path adjustment unit to the optical element, or to reflect the light emitted from the optical element to the optical path adjustment unit.

According to an aspect of the present disclosure, when the WDM module for a multimode light source operates as a multiplexer, the optical element includes a light receiving element to receive light incident into the optical element.

According to an aspect of the present disclosure, when the WDM module for a multimode light source operates as a demultiplexer, the optical element includes a light-emitting element to emit light of a preset wavelength band.

According to an aspect of the present disclosure, the base substrate includes seating units for disposing and fixing the optical fiber, the optical path conversion unit, and the optical element, respectively.

According to an aspect of the present disclosure, the seating unit for disposing the optical fiber protrudes vertically upward from the base substrate in a cross-sectional shape of the optical fiber, and seats the optical fiber on the seating unit.

According to an aspect of the present disclosure, the seating unit for disposing the optical path conversion unit or the optical element protrudes vertically upward from the base substrate in a structure of contacting one or more surfaces of each of the optical path conversion unit and the optical element, so that the optical path conversion unit and the optical element are seated.

According to an aspect of the present disclosure, the optical path conversion unit includes a diffraction grating for path conversion on one surface thereof.

According to an aspect of the present disclosure, the optical path conversion unit includes the diffraction grating, diffracts light emitted from one side at different angles depending on a wavelength band and allows the diffracted light to travel to different points or areas, or diffracts light of a plurality of wavelength bands incident from another side at different angles and allows the diffracted light to travel to the same point or area.

According to an aspect of the present disclosure, the collimator suppresses dispersion of the light emitted from the optical fiber by allowing the light to travel as parallel light.

According to an aspect of the present disclosure, the collimator prevents dispersion of zero-order diffraction light that has not been diffracted even though passing through the optical path conversion unit, thereby preventing the zero-order diffraction light from being incident into the optical element.

According to an aspect of the present disclosure, the reflection unit has a shape of a triangular pillar.

According to an aspect of the present disclosure, the WDM module for a multimode light source further includes a lens disposed between the reflection unit and the optical element on the optical path.

According to an aspect of the present disclosure, the lens focuses light incident into the lens.

According to an aspect of the present disclosure, the lens focuses light reflected by the reflection unit to the optical element, or prevents dispersion of light dispersed by and output from the optical element.

According to an aspect of the present disclosure, the reflection unit is implemented in the shape of a paraboloid.

According to an aspect of the present disclosure, the optical element is disposed with a bias toward one side from an axis along which light is emitted from the optical fiber.

According to an aspect of the present disclosure, the optical element is disposed with a bias in a direction in which the light emitted from the optical fiber is diffracted through the optical path conversion unit.

According to an aspect of the present disclosure, the WDM module for a multimode light source further includes an electrode configured to supply power to the optical element to enable the optical element to operate.

According to an aspect of the present disclosure, a WDM module for a multimode light source may include a base substrate, at least two optical elements configured to receive or output light of different wavelength bands, an optical path conversion unit disposed between an optical fiber for outputting or receiving light and the optical element on an optical path, and configured to convert the optical path so that light emitted from one component travels to another component, a collimator located between the optical path conversion unit and the optical element on the optical path, and configured to prevent dispersion of light traveling from one component to another component, and a reflection unit configured to reflect the light passing through the optical path adjustment unit to the optical element, or to reflect the light emitted from the optical element to the optical path adjustment unit.

According to an aspect of the present disclosure, the collimator is implemented as a single aspherical lens.

According to an aspect of the present disclosure, the collimator is provided in a plural number, and the plurality of collimators are disposed for optical paths incident on the optical elements, respectively, thereby preventing dispersion of light traveling from one component to another component.

According to an aspect of the present disclosure, the collimator is implemented as an off-axis freeform lens.

According to an aspect of the present disclosure, the collimator includes an off-axis lens disposed for each optical path incident on each optical element, and has a freeform lens shape in which the off-axis lenses are combined into one.

According to an aspect of the present disclosure, a WDM module for a multimode light source may include a base substrate, at least two optical elements configured to receive or output light of different wavelength bands, an optical path conversion unit disposed between an optical fiber for outputting or receiving light and the optical element on an optical path, and configured to convert the optical path so that light emitted from one component travels to another component, a micro lens located between the optical fiber and the optical path conversion unit on the optical path, and configured to adjust a beam width of the light emitted from the optical fiber, a collimator located between the optical path conversion unit and the optical element on the optical path, and configured to prevent dispersion of light traveling from one component to another component, and a reflection unit configured to reflect the light passing through the optical path adjustment unit to the optical element, or to reflect the light emitted from the optical element to the optical path adjustment unit.

According to an aspect of the present disclosure, the micro lens prevents dispersion of the light emitted from the optical fiber, or focuses the light emitted from the optical fiber.

As described above, an aspect of the present disclosure has advantages in that it can simplify the arrangement/structure of elements included therein and minimize changes in an optical path due to temperature change.

### BRIEF DESCRIPTION OF THE DRAWINGS

FIGS. 1A and 1B are plan views illustrating a construction of a WDM module for a multimode light source according to an embodiment of the present disclosure.

FIG. 2 is a diagram illustrating a construction of an optical path adjustment unit according to an embodiment of the present disclosure.

FIGS. 3A and 3B are diagrams illustrating a reflection unit and a light receiving unit according to a first embodiment of the present disclosure.

FIGS. 4A, 4B, 4C are diagrams illustrating a reflection unit and a light receiving unit according to a second embodiment of the present disclosure.

FIGS. 5A, 5B, 5C are plan views illustrating a construction of a WDM module for a multimode light source according to another embodiment of the present disclosure.

FIGS. 6A and 6B are diagrams illustrating an optical path adjusted by a micro lens according to another embodiment of the present disclosure.

### DETAILED DESCRIPTION

The present disclosure may be changed in various ways and may have various embodiments. Specific embodiments are to be illustrated in the drawings and specifically described. It should be understood that the present disclosure is not intended to be limited to the specific embodiments, but includes all of changes, equivalents and/or substitutions included in the spirit and technical range of the present disclosure. Similar reference numerals are used for similar components while each drawing is described.

Terms, such as a first, a second, A, and B, may be used to describe various components, but the components should not be restricted by the terms. The terms are used to only distinguish one component from another component. For example, a first component may be referred to as a second component without departing from the scope of rights of the present disclosure. Likewise, a second component may be referred to as a first component. The term “and/or” includes a combination of a plurality of related and described items or any one of a plurality of related and described items.

When it is described that one component is “connected” or “coupled” to the other component, it should be understood that one component may be directly connected or coupled to the other component, but a third component may exist between the two components. In contrast, when it is described that one component is “directly connected to” or “directly coupled to” the other component, it should be understood that a third component does not exist between the two components.

Terms used in this application are used to only describe specific embodiments and are not intended to restrict the present disclosure. An expression of the singular number includes an expression of the plural number unless clearly defined otherwise in the context. In this specification, a term, such as “include” or “have”, is intended to designate the presence of a characteristic, a number, a step, an operation, a component, a part, or a combination of them, and should be understood that it does not exclude the existence or possible addition of one or more other characteristics, numbers, steps, operations, components, parts, or combinations of them in advance.

All terms used herein, including technical terms or scientific terms, have the same meanings as those commonly understood by a person having ordinary knowledge in the art to which the present disclosure pertains, unless defined otherwise in the specification.

Terms, such as those defined in commonly used dictionaries, should be construed as having the same meanings as those in the context of a related technology, and are not construed as ideal or excessively formal meanings unless explicitly defined otherwise in the application.

Furthermore, each construction, process, procedure, or method included in each embodiment of the present disclosure may be shared within a range in which the constructions, processes, procedures, or methods do not contradict each other technically.

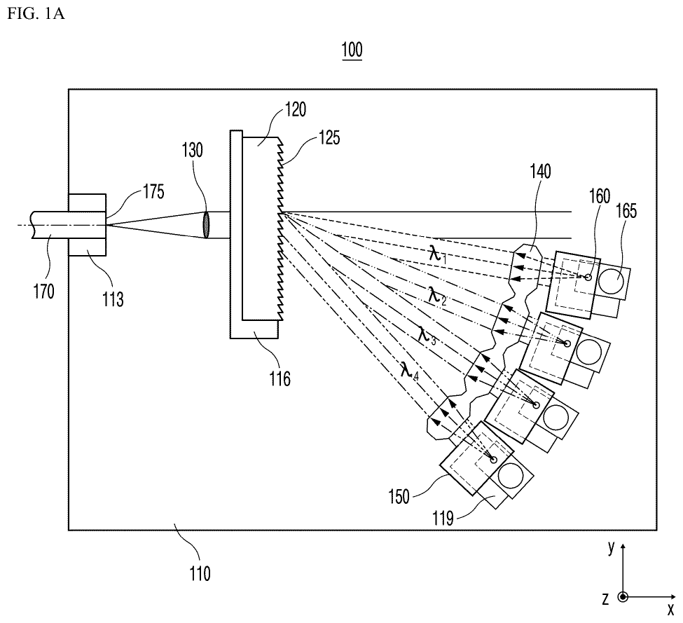

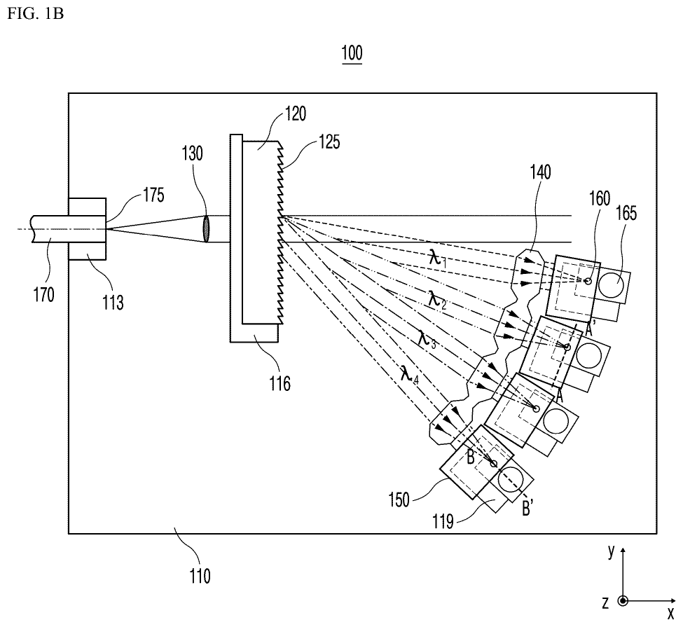

FIGS. 1A and 1B are plan views illustrating a construction of a WDM module for a multimode light source according to an embodiment of the present disclosure.

Referring to FIGS. 1A and 1B, a WDM module 100 for a multimode light source (hereinafter, abbreviated as a “module”) according to an embodiment of the present disclosure includes a base substrate 110, seating units 113, 116, and 119, an optical path conversion unit 120, a collimator 130, an optical path adjustment unit 140, a reflection unit 150, a plurality of optical elements 160, and an electrode 165.

The module 100 may support wavelength division multiplexing (WDM) optical communication in which multiple optical signals of different wavelengths may be transmitted through one optical fiber 170. The module 100 may form a plurality of communication channels by using one optical fiber 170. For example, as illustrated in FIG. 1A, the module 100 may operate as a multiplexer in which light of different wavelength bands 21 to 24 emitted from the plurality of optical elements 160 corresponding to a transmitting end of a communication channel is input to the one optical fiber 170 through the optical path conversion unit 120. As illustrated in FIG. 1B, the module 100 may also operate as a demultiplexer in which light of different wavelength bands 21 to 24 emitted from the one optical fiber 170 corresponding to a transmitting end of a communication channel is input to the optical elements 160, which receive light of different wavelength bands, through the optical path conversion unit 120. Alternatively, some optical elements 160 may operate as multiplexers and other optical elements 160 may operate as demultiplexers. For example, when the optical element 160 operating as a multiplexer is denoted as Tx and the optical element 160 operating as a demultiplexer is denoted as Rx, the module 100 may be implemented in a form including both a multiplexer such as 3Tx/1Tx or 2Tx/2Tx (assuming that four channels are included) and a demultiplexer. For convenience, FIGS. 1A and 1B illustrate an example in which the module 100 operates only as a multiplexer or only as a demultiplexer, but the present disclosure is not necessarily limited thereto.

The base substrate 110 provides a space where each component within the module 100 and the optical fiber 170 may be placed. Particularly, the base substrate 110 includes the respective seating units 113, 116, and 119, so that the optical fiber 170, the optical path conversion unit 120, and the optical element 160 may be easily disposed and fixed in correct positions.

The seating unit 113 protrudes vertically upward (z-axis direction) from the base substrate 110 in the cross-sectional shape of the optical fiber 170, so that the optical fiber 170 may be seated on the seating unit 113.

The seating units 116 and 119 protrude vertically upward (z-axis direction) from the base substrate 110 to be in contact with one or more surfaces of each of the optical path conversion unit 120 and the optical element 160, so that the optical path conversion unit 120 and the optical element 160 may be seated on the seating units 116 and 119, respectively. The seating unit 116 may completely contact only one surface of the component 120 and the seating unit 119 may completely contact only one surface of the component 160; however, in order to firmly fix the components 120 and 160, the seating unit 116 may contact at least two surfaces of the component 120 and the seating unit 119 may contact at least two surfaces of the component 160. For example, the seating units 116 and 119 may each have a ‘reverse L’ or ‘L’ shape, may be in contact with the components 120 and 160, respectively, on each surface thereof, and may fix the components 120 and 160, respectively.

The optical path conversion unit 120 is disposed between the optical fiber 170 and the optical element 160 on an optical path, and converts the optical path so that light emitted from one component may travel to another component. The optical path conversion unit 120 may include a diffraction grating 125 for path conversion on one surface thereof (illustrated on a surface remote from the optical fiber in FIG. 1). Accordingly, the optical path conversion unit 120 may diffract light emitted from one side at different angles depending on a wavelength band and allow the diffracted light to travel to different points or areas, or diffract light of a plurality of wavelength bands incident from another side at different angles and allow the diffracted light to travel to the same point or area. More specifically, the optical path conversion unit 120 receives light emitted from the optical fiber 170, diffracts the received light at different angles depending on a wavelength band, and diffracts light with a longer wavelength band at a larger diffraction angle. Accordingly, light of a relatively short wavelength band is diffracted to the optical element 160 disposed closer to an axis on which the light is emitted from the optical fiber 170 and travels, and light of a relatively long wavelength band is diffracted to the optical element 160 disposed farther from the axis on which the light is emitted from the optical fiber 170 and travels. On the other hand, the optical path conversion unit 120 diffracts light incident from different directions or angles emitted from the optical elements 160, at different angles according to a wavelength band. The optical path conversion unit 120 diffracts each light at different angles and allows the diffracted light to travel to a point or an area of the optical fiber 170, more specifically, an end portion 175 that receives the light of the optical fiber 170.

The collimator 130 is located between the optical fiber 170 and the optical path conversion unit 120 on the optical path, thereby allowing the light emitted from the optical fiber 170 to travel as parallel light and allowing the light diffracted by the optical path conversion unit 120 to be focused to the optical fiber 170. The collimator 130 is disposed at the above-described position, and suppresses dispersion of the light emitted from the optical fiber 170 by allowing the light to travel as parallel light. As the collimator 130 is disposed at the above-described position and performs the above-described operation, it is possible to prevent dispersion of zero-order diffraction light that has not been diffracted even though the light passes through the optical path conversion unit 120. When the module 100 operates as a multiplexer (structure in which light emitted from the optical fiber is incident into the optical element), zero-order diffraction light among the light emitted from the optical fiber 170 is not preferably incident into the optical element 160. Only light of a specific wavelength band diffracted at an appropriate angle needs be incident into the optical element 160, and zero-order diffraction light serves as noise from the perspective of the optical element 160. However, since the conventional WDM module does not include the collimator 130, zero-order diffraction light emitted from the optical fiber 170 continues to be dispersed while passing through the optical path conversion unit 120 and travels. Therefore, there has been a problem in that zero-order diffraction light serving as noise is incident into optical elements in the conventional WDM module. The collimator 130 prevents dispersion of the light emitted from the optical fiber 170 at the above-described position, thereby preventing zero-order diffraction light from being incident into the optical element 160, particularly, the optical element 160 disposed closer to an axis on which light is emitted from the optical fiber 170.

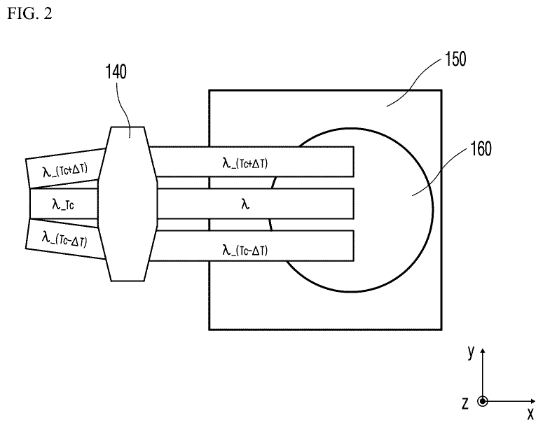

The optical path adjustment unit 140 is disposed between the optical path conversion unit 120 and the optical element 160 on the optical path, and adjusts the path of light traveling from one component to another component. The structure and operation of the optical path adjustment unit 140 are illustrated in detail in FIG. 2.

FIG. 2 is a diagram illustrating the configuration of the optical path adjustment unit according to an embodiment of the present disclosure.

Referring to FIG. 2, the optical path within the module 100 needs to proceed as designed. However, when the internal temperature of the module 100 changes from a designed value, the path of light traveling within the module 100 changes from the designed optical path (for example, λ__{Tc} in FIG. 2). When the internal temperature of the module 100 changes from the designed value, a problem occurs in which light is diffracted more or less than an angle at which the light needs to be diffracted in the optical path conversion unit 120. In order to solve such a problem, the module 100 includes the optical path adjustment unit 140. The optical path adjustment unit 140 includes a surface in a direction perpendicular to incident light at a point or an area where the light flowing in along the designed optical path is incident, and may include a surface having a constant angle from a direction perpendicular to incident light at a point or an area where light flowing in along a path (e.g., Δ_{Tc}-ΔT or λ_{Tc}+ΔT in FIG. 2) changed due to a temperature change is incident. For example, the optical path adjustment unit 140 may have an octagonal cross-section as illustrated in FIG. 2. Accordingly, the optical path adjustment unit 140 may adjust the path of light traveling (dispersed) at an angle deviated from the designed optical path due to temperature changes to follow the direction or angle of the designed optical path.

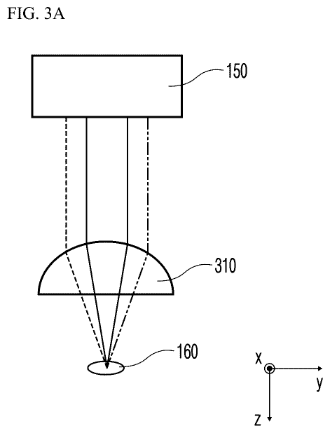

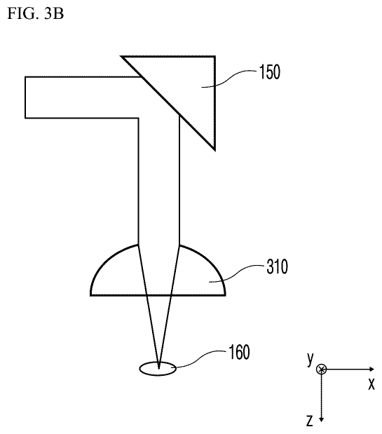

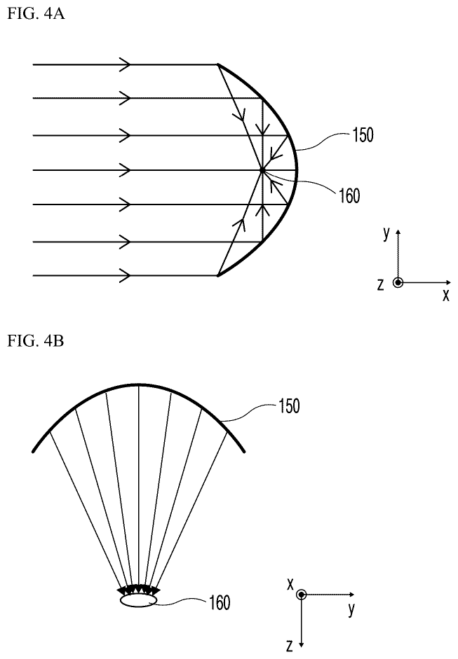

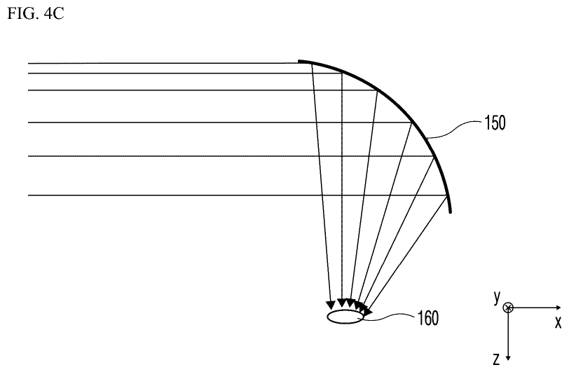

Referring back to FIG. 1A or 1B, the reflection unit 150 reflects light having passed through the optical path adjustment unit 140 to the optical element 160, or reflects light emitted from the optical element 160 to the optical path adjustment unit 140. The structure for the reflection unit 150 to reflect light incident into the reflection unit 150 is illustrated in FIGS. 3 and 4.

FIGS. 3A and 3B are diagrams illustrating a reflection unit and a light receiving unit according to a first embodiment of the present disclosure. FIG. 3A illustrates a cross section of the reflection unit and the light receiving unit in the A-A′ direction in FIG. 1B, and FIG. 3B illustrates a cross section of the reflection unit and the light receiving unit in the B-B′ direction in FIG. 1B.

Referring to FIGS. 3A and 3B, the reflection unit 150 according to the first embodiment of the present disclosure is implemented in the shape of a triangular pillar, and reflects light emitted from or passing through one component 140 or 160 to another component 160 or 140. Since the reflection unit 150 is implemented in the shape of a triangular pillar, the reflection unit 150 may be relatively small and easily disposed, and the placement position thereof may be easily adjusted as long as a reflecting surface of the reflection unit 150 is located vertically above the optical element 160.

When the reflection unit 150 is implemented in the shape of a triangular pillar, a lens 310 may be disposed between the reflection unit 150 and the optical element 160 on the optical path. The lens 310 is placed at the corresponding position and focuses light incident into the lens 310, like a convex lens. That is, the lens 310 focuses light reflected by the reflection unit 150 through the optical path adjustment unit 140 to the optical element 160, or prevents dispersion of light dispersed by and output from the optical element 160 and allows the light to travel to the reflection unit 150.

FIGS. 4A, 4B, 4C are diagrams illustrating a reflection unit and a light receiving unit according to a second embodiment of the present disclosure. FIG. 4A illustrates a cross section of the reflection unit and the light receiving unit in the A-A′ direction in FIG. 1B, and FIG. 4B illustrates a cross section of the reflection unit and the light receiving unit in the B-B′ direction in FIG. 1B.

Referring to FIGS. 4A, 4B, 4C, the reflection unit 150 according to the second embodiment of the present disclosure is implemented in the shape of a paraboloid. That is, the reflection unit 150 has an elliptical cross-section in a plane perpendicular to an axis along which light travels, but has a parabolic shape in any direction in its cross-section in the plane perpendicular to the axis perpendicular to the axis along which light travels. Since the reflection unit 150 is implemented in the shape of a paraboloid described above, even though light is incident into the reflection unit 150 in any direction from one component 140 or 160, the reflection unit 150 may reflect the light to a point or an area of the other component 160 or 140 even without the separate lens 310.

Referring back to FIG. 1A or 1B, at least two optical elements 160 are provided to receive or output light of different wavelength bands. When the module 100 operates as a multiplexer, the optical element 160 includes a light receiving element and receives light incident thereon through the reflection unit 150. When the module 100 operates as a demultiplexer, the optical element 160 includes a light-emitting element and emits light of a preset wavelength band to the reflection unit 150.

The optical element 160 is disposed with a bias toward one side from the axis along which light is emitted from the optical fiber 170, more specifically, in the direction in which light is diffracted through the optical path conversion unit 120. As the optical elements 160 are arranged to be spaced apart from one another by a preset interval, the optical elements 160 may separately receive only light of a specific wavelength band. On the other hand, the optical element 160 disposed relatively close to the axis on which light is emitted from the optical fiber 170 receives or emits light of a relatively short wavelength band, and as the optical element 160 is relatively away from the axis, the optical element 160 receives or emits light of a relatively long wavelength band.

The electrode 165 supplies power to the optical element 160 to enable the optical element 160 to operate.

As the optical module 100 includes the above-described components, the optical module 100 can have temperature-resistant characteristics and each component can be easily arranged to operate without error.

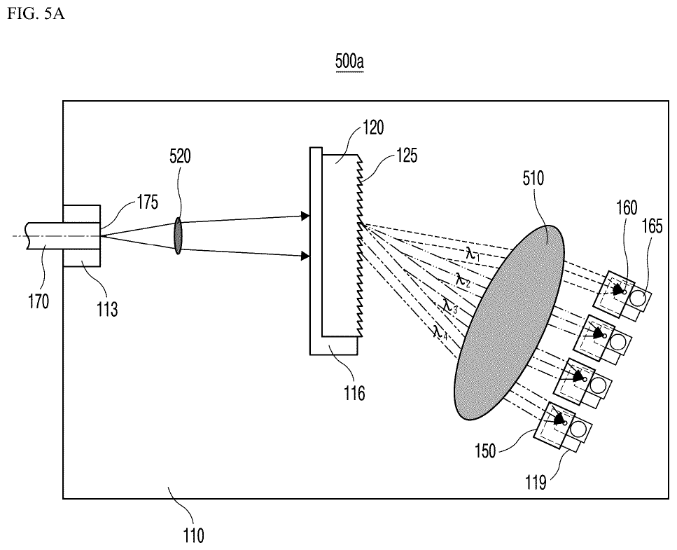

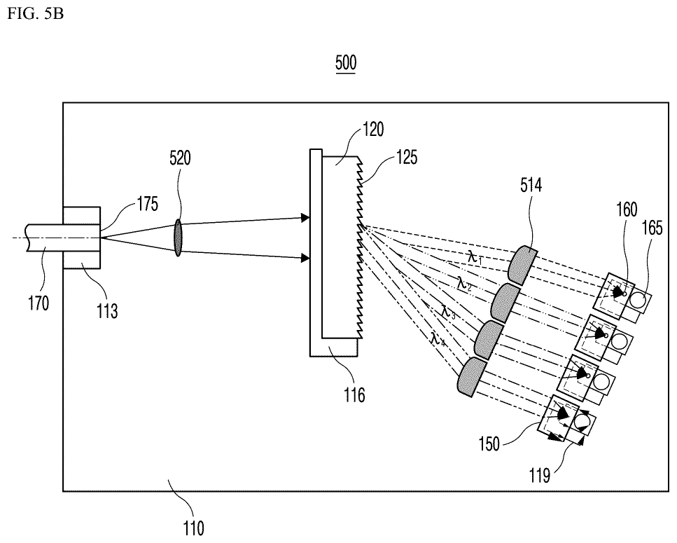

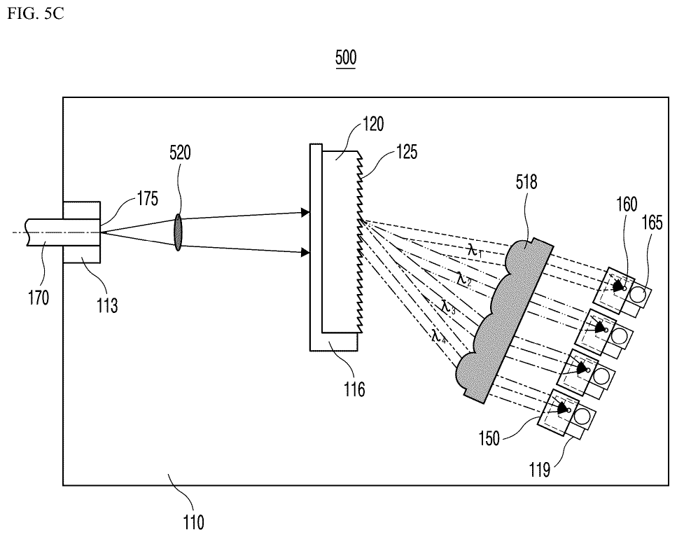

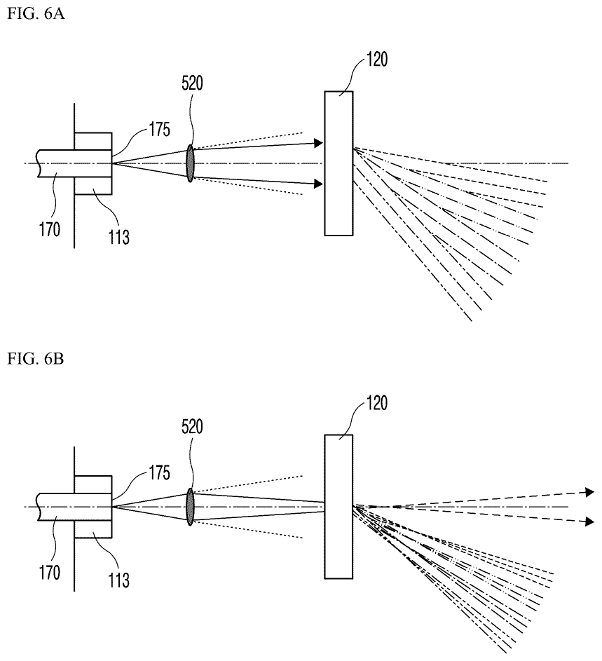

FIGS. 5A, 5B, 5C are plan views illustrating the configuration of a WDM module for a multimode light source according to another embodiment of the present disclosure, and FIG. 6 is a diagram illustrating an optical path adjusted by a micro lens according to another embodiment of the present disclosure.

Referring to FIG. 5A, a WDM module 500 for a multi-mode light source (hereinafter, abbreviated as ‘module’) according to another embodiment of the present disclosure includes a base substrate 110, seating units 113, 116, and 119, an optical path conversion unit 120, a reflection unit 150, a plurality of optical elements 160, an electrode 165, and a collimator 510, 514, or 518, and may further include a micro lens 520.

Since the base substrate 110, the seating units 113, 116, and 119, the optical path conversion unit 120, the reflection unit 150, the optical element 160, and the electrode 165 perform the same operations as those in the module 100, detailed description thereof will be omitted.

The collimator 510, like the optical path adjustment unit 140, is disposed between the optical path conversion unit 120 and the optical element 160 on the optical path to prevent dispersion of light traveling from one component to another component. The collimator 510 is disposed at the above-described position, and particularly, is disposed so that light emitted from the optical element 160 and reflected by the reflection unit 150 may be focused on a point or an area within the optical fiber 170 through the collimator 510 and the optical path conversion unit 120. The collimator 510 prevents dispersion of light traveling to the optical element 160 through the optical path conversion unit 120. Accordingly, the light traveling through the optical path conversion unit 120 may be reflected by the above-described reflection unit 150 and enter a point or an area of the optical element 160. On the other hand, at the above-described position, the collimator 510 may prevent the light emitted from the optical element 160 and reflected by the reflection unit 150 from being dispersed when the light travels to the optical path conversion unit 120. As the collimator 510 is disposed at the above-described position, the optical elements 160 may be arranged side by side without curvature.

When the collimator 510 does not exist, since dispersion of light is not avoidable, the optical elements 160 need be arranged with a curvature. Otherwise, when the optical elements 160 are arranged in parallel, the optical elements 160 need be excessively spaced apart from each other in order to prevent interference between the optical elements 160. However, as the collimator 510 is disposed at the above-described position, the optical elements 160 need not be excessively spaced apart from each other as in the related art even though the optical elements 160 are arranged side by side without curvature. Even though the optical elements 160 are separated by the same or similar distance from the optical elements 160 in the module 100, the optical elements 160 can receive only light of a wavelength band they wish to receive, without interference between the optical elements 160.

The collimator 514 may be implemented as illustrated in FIG. 5B. The collimator 510 may be implemented as a single aspherical lens as illustrated in FIG. 5A, but as illustrated in FIG. 5B, a plurality of collimators 514 may be disposed for channels (meaning optical paths incident on optical elements), respectively, thereby preventing dispersion of light traveling from one component to another component. When the collimator 510 is implemented as a single aspherical lens, since parallel light may not be generated for all channels, all positions, or all paths, chromatic aberration may occur. On the other hand, when the plurality of collimators 514 are disposed for channels, respectively, the occurrence of the above-described problem can be prevented.

The collimator 518 may be implemented as illustrated in FIG. 5C. Unlike the collimator 514, the collimator 518 may be implemented as an off-axis freeform lens. Like the collimator 514, the collimator 518 includes an off-axis lens provided for each channel to transform incident light into parallel light, and has a freeform lens shape in which the off-axis lenses are combined into one. As the collimator 518 has such a structure, the collimator 518 can be relatively easily disposed and aligned compared to the collimator 514.

The micro lens 520 is located between the optical fiber 170 and the optical path conversion unit 120 on the optical path, and adjusts a beam width of light emitted from the optical fiber 170. The micro lens 520 may adjust a beam width or a path of light incident into the micro lens 520, and particularly, may adjust the beam width of light emitted from the optical fiber 170. The micro lens 520 prevents the light emitted from the optical fiber 170 from being excessively dispersed as illustrated in FIG. 6A, or focuses the light emitted from the optical fiber 170 as illustrated in FIG. 6B to prevent zero-order diffraction light from being incident into the optical element 160 as described above. In addition, the micro lens 520 may also prevent light of wavelength bands, other than light of a wavelength band that is to be incident into each optical element 160, from being incident (it is obvious that such an effect occurs when the module includes the collimator 130).

As the optical module 500 also includes the above-described components, the optical module 500 can have temperature-resistant characteristics and each component can be easily disposed to operate without error.

The above description is merely a description of the technical spirit of the present embodiment, and those skilled in the art may change and modify the present embodiment in various ways without departing from the essential characteristic of the present embodiment. Accordingly, the embodiments should not be construed as limiting the technical spirit of the present embodiment, but should be construed as describing the technical spirit of the present embodiment. The technical spirit of the present embodiment is not restricted by the embodiments. The range of protection of the present embodiment should be construed based on the following claims, and all of technical spirits within an equivalent range of the present embodiment should be construed as being included in the scope of rights of the present embodiment.

What is claimed is:

1. A WDM module for a multimode light source, comprising:
a base substrate;
at least two optical elements configured to receive or output light of different wavelength bands;
an optical path conversion unit disposed between an optical fiber for outputting or receiving light and the optical element on an optical path, and configured to convert the optical path so that light emitted from one component travels to another component;
a collimator located between the optical fiber and the optical path conversion unit on the optical path, and configured to allow the light emitted from the optical fiber to travel as parallel light and allow the light with a path changed by the optical path conversion unit to be focused to the optical fiber;
an optical path adjustment unit located between the optical path conversion unit and the optical element on the optical path, and configured to adjust a path of light traveling from one component to another component; and
a reflection unit configured to reflect the light passing through the optical path adjustment unit to the optical element, or to reflect the light emitted from the optical element to the optical path adjustment unit.

2. The WDM module for a multimode light source of claim 1, wherein, when the WDM module for a multimode light source operates as a multiplexer, the optical element includes a light receiving element to receive light incident into the optical element.

3. The WDM module for a multimode light source of claim 1, wherein, when the WDM module for a multimode light source operates as a demultiplexer, the optical element includes a light-emitting element to emit light of a preset wavelength band.

4. The WDM module for a multimode light source of claim 1, wherein the base substrate comprises seating units for disposing and fixing the optical fiber, the optical path conversion unit, and the optical element, respectively.

5. The WDM module for a multimode light source of claim 4, wherein the seating unit for disposing the optical fiber protrudes vertically upward from the base substrate in a cross-sectional shape of the optical fiber, and seats the optical fiber on the seating unit.

6. The WDM module for a multimode light source of claim 4, wherein the seating unit for disposing the optical path conversion unit or the optical element protrudes vertically upward from the base substrate in a structure of contacting one or more surfaces of each of the optical path conversion unit and the optical element, so that the optical path conversion unit and the optical element are seated.

7. The WDM module for a multimode light source of claim 1, wherein the optical element is disposed with a bias toward one side from an axis along which light is emitted from the optical fiber.

8. The WDM module for a multimode light source of claim 7, wherein the optical element is disposed with a bias in a direction in which the light emitted from the optical fiber is diffracted through the optical path conversion unit.

9. The WDM module for a multimode light source of claim 1, further comprising:
an electrode configured to supply power to the optical element to enable the optical element to operate.

10. A WDM module for a multimode light source, comprising:
a base substrate;
at least two optical elements configured to receive or output light of different wavelength bands;
an optical path conversion unit disposed between an optical fiber for outputting or receiving light and the optical element on an optical path, and configured to convert the optical path so that light emitted from one component travels to another component;
a collimator located between the optical path conversion unit and the optical element on the optical path, and configured to prevent dispersion of light traveling from one component to another component; and
a reflection unit configured to reflect the light passing through an optical path adjustment unit to the optical element, or to reflect the light emitted from the optical element to the optical path adjustment unit.

11. The WDM module for a multimode light source of claim 10, wherein the collimator is implemented as a single aspherical lens.

12. The WDM module for a multimode light source of claim 10, wherein the collimator is provided in a plural number, and the plurality of collimators are disposed for optical paths incident on the optical elements, respectively, thereby preventing dispersion of light traveling from one component to another component.

13. The WDM module for a multimode light source of claim 10, wherein the collimator is implemented as an off-axis freeform lens.

14. The WDM module for a multimode light source of claim 13, wherein the collimator comprises an off-axis lens disposed for each optical path incident on each optical element, and has a freeform lens shape in which the off-axis lenses are combined into one.

15. A WDM module for a multimode light source, comprising:
a base substrate;
at least two optical elements configured to receive or output light of different wavelength bands;
an optical path conversion unit disposed between an optical fiber for outputting or receiving light and the optical element on an optical path, and configured to convert the optical path so that light emitted from one component travels to another component;
a micro lens located between the optical fiber and the optical path conversion unit on the optical path, and configured to adjust a beam width of the light emitted from the optical fiber;
a collimator located between the optical path conversion unit and the optical element on the optical path, and configured to prevent dispersion of light traveling from one component to another component; and
a reflection unit configured to reflect the light passing through an optical path adjustment unit to the optical element, or to reflect the light emitted from the optical element to the optical path adjustment unit.

16. The WDM module for a multimode light source of claim 15, wherein the micro lens prevents dispersion of the light emitted from the optical fiber, or focuses the light emitted from the optical fiber.
